(19) United States
(12) Patent Application Publication
(10) Pub. No.: US 2020/0033149 A1
(43) Pub. Date: Jan. 30, 2020

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Kosuke KOTAKE, Nagoya-shi (JP); Ryosuke TANIMURA, Toyota-shi (JP); Yuki ITO, Iwakura-shi (JP); Akira NISHIDA, Toyota-shi (JP); Zekai QIU, Nisshin-shi (JP); Kenichi HAGIYA, Nagoya-shi (JP); Naoki YAMAMURO, Nagoya-shi (JP)

(73) Assignee: TOYOTA JIDOSHA KABUSHIKI KAISHA, Toyota-shi (JP)

(21) Appl. No.: 16/520,478

(22) Filed: Jul. 24, 2019

(30) Foreign Application Priority Data
Jul. 24, 2018 (JP) 2018-138421

(51) Int. Cl. G01C 21/34; G08G 1/00; G08G 1/14

(52) U.S. Cl. CPC G01C 21/3438; G08G 1/141; G08G 1/202

(57) ABSTRACT

An information processing apparatus includes a control unit configured to: acquire a schedule information piece in which a first vehicle that a visitor schedules to ride in when a visitor visits a facility is specified; and if the number of visiting vehicles is predicted to be equal to or larger than a first predetermined number based on the respective schedule information pieces, calculate ride-sharing user candidates that are candidates of visitors that each join a ride in a vehicle, to visit the predetermined facility, and second vehicles that the ride-sharing user candidates can join a ride in, and perform matching between a part or all of users in the ride-sharing user candidates and the second vehicles so that the number of visiting vehicles becomes smaller than the first predetermined number.

### CROSS REFERENCE TO THE RELATED APPLICATION

This application claims the benefit of Japanese Patent Application No. 2018-138421, filed on Jul. 24, 2018, which is hereby incorporated by reference herein in its entirety.

### BACKGROUND

### Technical Field

The present disclosure relates to an information processing apparatus and. an information processing method.

### Description of the Related Art

In recent years, use of what is called “ride sharing”, which is a form of transportation in which a plurality of users share a ride in a same vehicle, has been prevailing. Also, for use of such ride sharing, techniques for matching a plurality of users with each other have been developed.

Also, Patent Document 1 discloses a technique for determining whether or not respective owners of terminals share a ride in a same vehicle.

### CITATION LIST

### Patent Document

[Patent document 1] Japanese Patent Laid-Open No. 2011-237842

### SUMMARY

An object of the present disclosure is to provide a ride-sharing technique that enables alleviation of congestion caused by vehicles visiting a predetermined facility.

An information processing apparatus according to the present disclosure may include a control unit configured to: for each of a plurality of visitors who visit a predetermined facility by vehicle, acquire a schedule information piece which is an information piece relating to a schedule for the visitor to visit to the facility, a first vehicle being specified in the schedule information piece, the first vehicle being a vehicle that the visitor schedules to ride in when the visitor visits the facility; and if the number of a plurality of visiting vehicles visiting the predetermined facility during a predetermined period of time is predicted to be equal to or larger than a first predetermined number based on the respective schedule information pieces of the plurality of visitors, calculate ride-sharing user candidates that are candidates of visitors that each join a ride in a vehicle that is different from the first vehicle specified in the schedule information piece of the relevant visitor, to visit the predetermined facility during the predetermined period of time, from among the plurality of visitors, and second vehicles that are vehicles that the ride-sharing user candidates can join a ride in, each of the second vehicles being the first vehicle for a visitor that is different from the ride-sharing user candidates, and perform matching between a part or all of users in the calculated ride-sharing user candidates and the second vehicles so that the number of the plurality of visiting vehicles becomes smaller than the first predetermined number.

Also, an aspect of the present disclosure can provide an information processing method. For example, the present disclosure may provide an information processing method including the steps of: for each of a plurality of visitors who visit a predetermined facility by vehicle, acquiring a schedule information piece which is an information piece relating to a schedule for the visitor to visit to the facility, a first vehicle being specified in the schedule information piece, the first vehicle being a vehicle that the visitor schedules to ride in when the visitor visits the facility; and if the number of a plurality of visiting vehicles visiting the predetermined facility during a predetermined period of time is predicted to be equal to or larger than a first predetermined number based on the respective schedule information pieces of the plurality of visitors, calculating ride-sharing user candidates that are candidates of visitors that each join a ride in a vehicle that is different from the first vehicle specified in the schedule information piece of the relevant visitor, to visit the predetermined facility during the predetermined period of time, from among the plurality of visitors, and second vehicles that are vehicles that the ride-sharing user candidates can join a ride in, each of the second vehicles being the first vehicle for a visitor that is different from the ride-sharing user candidates, and performing matching between a part or all of users in the calculated ride-sharing user candidates and the second vehicles so that the number of the plurality of visiting vehicles becomes smaller than the first predetermined number. Then, the present disclosure may provide a non-transitory recording medium storing a program for causing a computer to execute such an information processing method,

The present disclosure enables provision of a ride-sharing technique that enables alleviation of congestion caused by vehicles visiting a predetermined facility.

### BRIEF DESCRIPTION OF THE DRAWINGS

FIG. 1 is a diagram illustrating a schematic configuration of an information processing system according to a first embodiment;

FIG. 2 is a diagram illustrating of respective exemplary hardware configurations of a user terminal and a server apparatus in the information processing system;

FIG. 3 is a diagram illustrating a functional configuration of a server apparatus according to the first embodiment;

FIG. 4 is a diagram illustrating an example of a schedule information table according to the first embodiment;

FIG. 5 is a diagram indicating a positional relationship of spots illustrated in FIG. 4;

FIG. 6A is a diagram illustrating an example of a traffic information table;

FIG. 6B is a diagram illustrating an example of a traffic information table;

FIG. 6C is a diagram illustrating an example of a traffic information table;

FIG. 7A is a diagram illustrating an example of a matching information table;

FIG. 7B is a diagram illustrating an example of a matching information table;

FIG. 8 is a flowchart of processing performed by a server apparatus;

FIG. 9 is a first diagram illustrating travel routes in the periphery of a predetermined facility;

FIG. 10 is a first diagram indicating a passage rate and the number of vehicles scheduled to enter for each entrance;

FIG. 11 is a diagram illustrating a functional configuration of a server apparatus according to an alteration oaf the first embodiment;

FIG. 12 is a second diagram indicating a passage rate and the number of vehicles scheduled to enter for each entrance;

FIG. 13 is a second diagram illustrating travel routes in the periphery of a predetermined facility;

FIG. 14 is a diagram illustrating a schematic configuration of an information processing system according to a second embodiment;

FIG. 15 is a diagram illustrating an example of the flow of operation of the information processing system according to the second embodiment;

FIG. 16 is a diagram illustrating an example of a schedule information table according to the second embodiment; and

FIG. 17 is a diagram illustrating an example of a changed schedule information table.

### DESCRIPTION OF THE EMBODIMENTS

Where the number of vehicles visiting a predetermined facility (visiting vehicles) during a predetermined period of time becomes equal to or larger than a first predetermined number, congestion is caused by the vehicles. The term “congestion” mentioned here includes congestion of a parking lot attached to a predetermined facility and congestion of a road leading to the facility or the parking lot. Also, the first predetermined number may be, for example, a number determined based on a capacity of a parking lot attached to a predetermined facility.

Here, where it is assumed that the first predetermined number set to a number close to a capacity of a parking lot, if the number of visiting vehicles becomes equal to or larger than the first predetermined number, even though a vehicle enters the parking lot, the vehicle fails to be smoothly parked. As a result, congestion of the parking lot and congestion of a road leading to the parking lot occur.

Also, even where a capacity of a parking lot is relatively large, if the number of entrances to the parking lot is small relative to the capacity, which thus becomes a bottleneck to the flow of vehicles, congestion of a road leading to the parking lot may occur although the parking lot is relatively empty. In this case, the first predetermined number may be set based on easiness of entry to the parking lot. In other words, even if parking lots have a same capacity, the first predetermined number may be set to be larger for a parking lot that is easy to enter than for a parking lot that is difficult to enter.

Therefore, an information processing apparatus according to the present disclosure enables predicting whether or not the number of visiting vehicles becomes equal to or larger than a first predetermined number, by acquiring schedule information pieces. Then, if the number of visiting vehicles is predicted to become equal to or larger than the first predetermined number, a control unit may perform ride-sharing matching for making a plurality of users ride in a same vehicle so that the number of visiting vehicles becomes smaller than the first predetermined number. More specifically, the control unit may calculate ride-sharing user candidates, which are candidates of visitors to share a ride to visit a predetermined facility during a predetermined period of time and, for each of the ride-sharing user candidates, calculate a second vehicle that is a vehicle that the ride-sharing user candidate can join a ride in, the vehicle being a first vehicle for a visitor that is different from the ride-sharing user candidate. Then, a part or all of users in the calculated ride-sharing user candidates may be matched with the respective second vehicles.

Then, each of the ride-sharing user candidates matched with the respective second vehicles joins a ride in the relevant second vehicle to visit the predetermined facility, and the number of visiting vehicles is thus decreased. Hereinafter, a ride-sharing user candidate that is matched with a second vehicle and joins a ride in the second vehicle to visit a predetermined facility may be referred to as “ride-sharing user”. Therefore, as a result of ride-sharing matching being performed so that the number of visiting vehicles becomes smaller than the first predetermined number, congestion caused by visiting vehicles is suppressed to the extent possible. In other words, the information processing apparatus according to the present disclosure enables provision of a ride-sharing system that enables alleviation of congestion caused by visiting vehicles.

Specific embodiments of the present disclosure will be described below with reference to the drawings. Unless otherwise stated, dimensions, materials, shapes, relative dispositions, etc., of the components described in the below embodiments are not intended to limit the technical scope of the disclosure thereto.

### First Embodiment

### System Configuration

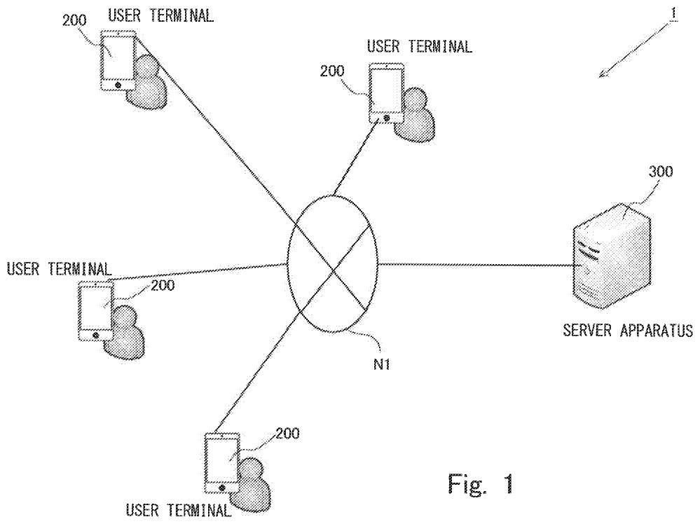

FIG. 1 is a diagram illustrating a schematic configuration of an information processing system according to the present embodiment. In the example illustrated in FIG. 1, an information processing system 1 includes user terminals 200 that respective users using the system have, and a server apparatus 300. Note that there are a number of user terminals 200, the number being equal to the number of users using the information processing system 1.

In the information processing system 1, the respective user terminals 200 and the server apparatus 300 are interconnected by a network N1. For the network N1, for example, a WAN (wide area network), which is a worldwide public communication network such as the Internet, or another communication network may be employed. Also, the network N1 may include a telephone communication network for, e.g., mobile phones and a wireless communication network for, e.g., WiFi.

A user using the information processing system 1 can input information relating to a schedule of the user himself/herself visiting a predetermined facility by vehicle (hereinafter “schedule information (piece)”) using his/her user terminal 200. Here, in each user terminal 200, a predetermined application for using the information processing system 1 (hereinafter may be referred to as “predetermined application”) has been installed and each user can input schedule information using the predetermined application installed in his/her user terminal 200. However, the above is not intended to limit a form of an input of schedule information to the form in which schedule information is input using a user terminal 200, and schedule information may be input using an arbitrary terminal that is connectable to the network N1 a smartphone, a mobile phone, a tablet terminal, a personal digital assistant or a wearable computer) or a personal computer (PC).

Here, the predetermined facility is an arbitrary facility that a user can visit by vehicle. Also, the schedule information includes information relating to a vehicle that a user is scheduled to ride in when the user visits the facility (hereinafter may be referred to as “first vehicle”), in addition to a schedule of the visit to the predetermined facility.

The server apparatus 300 is a management server that accepts registrations of schedule information pieces input using user terminals 200 and manages traffic to a predetermined facility. Here, the server apparatus 300 predicts whether or not congestion is caused by vehicles visiting the predetermined facility, based on the schedule information pieces and traffic information of traffic in the periphery of the predetermined facility (the traffic information includes, e.g., a current condition of the traffic in the periphery of the facility, a capacity of a parking lot attached to the predetermined facility and the number of vehicles currently parked, and information relating to entrances to the parking lot). Then, if congestion is predicted to occur, the server apparatus 300 performs ride-sharing matching for making a plurality of users share a ride in a same vehicle. Details of matching processing will be described later.

### Hardware Configuration

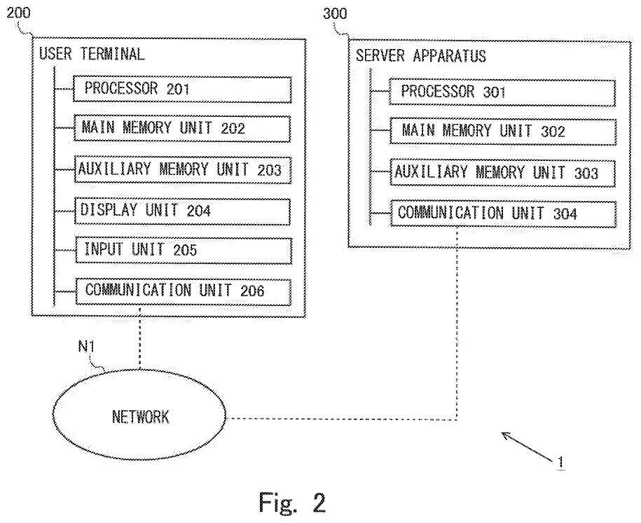

FIG. 2 is a diagram illustrating respective exemplary hardware configurations of a user terminal 200 and the server apparatus 300.

First, the server apparatus 300 will be described. The server apparatus 300 has a configuration of a general computer. The server apparatus 300 includes a processor 301, a main memory unit 302, an auxiliary memory unit 303 and a communication unit 304. These components are interconnected via a bus. Each of the main memory unit 302 and the auxiliary memory unit 303 is a computer-readable recording medium. The hardware configuration of the computer is not limited to the example illustrated in FIG. 2 and arbitrary omission, replacement and/or addition of components are possible.

In the server apparatus 300, the processor 301 loads a program stored in a recording medium to a work area of the main memory unit 302 and executes the program, and, e.g., respective functional component units are controlled through the execution of the program, enabling provision of functions meeting a predetermined purpose.

The processor 301 is, for example, a CPU (central processing unit) or a DSP (digital signal processor). The processor 301 controls the server apparatus 300 and performs various arithmetic operations for information processing. The main memory unit 302 includes a RAM (random access memory) and a ROM (read-only memory). The auxiliary memory unit 303 is, for example, an EPROM (erasable programmable ROM) or a hard disk drive (HDD). Also, the auxiliary memory unit 303 can include a removable medium, that is, a portable recording medium. The removable medium is, for example, a USB (universal serial bus) memory or a disk recording medium such as a CD (compact disc) or a DVD (digital versatile disc).

The auxiliary memory unit 303 stores various programs, various data and various tables in a recording medium in such a manner that programs, data and tables can be read/written. In the auxiliary memory unit 303, e.g., an operating system (OS), various programs and various tables are stored. Information to be stored in the auxiliary memory unit 303 may be stored in the main memory unit 302. Also, information to be stored in the main memory unit 302 may be stored in the auxiliary memory unit 303.

The communication unit 304 is connected to another apparatus and controls communication between the server apparatus 300 and the other apparatus. The communication unit 304 is, for example, a LAN (local area network) interface board or a wireless communication circuit for wireless communication. The LAN interface board or the wireless communication circuit is connected to the network N1 such as the Internet, which is a public communication network.

A series of processing performed by the server apparatus 300 can be performed by hardware but may also be performed by software.

Next, the user terminal 200 will be described. The user terminal 200 is, for example, a compact computer such as a smartphone, a mobile phone, a tablet terminal, a personal digital assistant or a wearable computer (e.g., a smart watch). Note that the user terminal 200 may be a personal computer (PC) connected to the server apparatus 300 via the network N1 such as the Internet, which is a public communication network.

The user terminal 200 includes a processor 201, a main memory unit 202, an auxiliary memory unit 203, a display unit 204, an input unit 205 and a communication unit 206. The processor 201, the main memory unit 202 and the auxiliary memory unit 203 are similar to the processor 301, the main memory unit 302 and the auxiliary memory unit 303 of the server apparatus 300, respectively, and thus, description thereof will be omitted. The display unit 204 is, for example, an LCD (liquid-crystal display) or an EL (electroluminescence) panel. The input unit 205 includes, e.g., a touch panel, push-buttons. Also, the input unit 205 can include a camera that enables an input of video or an image and an audio input unit such as a microphone. The communication unit 206 is, for example, a communication circuit for accessing the network N1 using a telephone communication network for, e.g., mobile phones or a wireless communication for, e.g., WiFi, and performing data communication with, e.g., the server apparatus 300.

### Functional Configuration of Server Apparatus

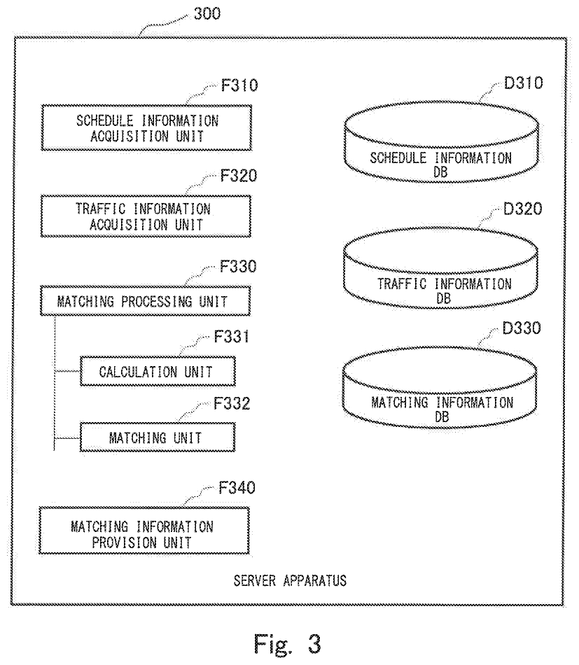

FIG. 3 is a diagram illustrating an example of a functional configuration of the server apparatus 300. The server apparatus 300 includes a schedule information acquisition unit F310, a traffic formation acquisition unit F320, a matching processing unit F330, a matching information provision unit F340, a schedule information database D310, a traffic information database D320 and a matching information database D330 as functional components. Also, the matching processing unit F330 includes a calculation unit F331 and a matching unit F332. The processor 301 of the server apparatus 300 performs processing in the schedule information acquisition unit F310, processing in the traffic information acquisition unit F320, processing in the matching processing unit F330 (the calculation unit F331 and the matching unit F332) and processing in the matching information provision unit F340 according to respective computer programs in the man memory unit 302. However, any of the functional components or a part of the processing in any of the functional components may be provided or performed by a hardware circuit.

Each of the schedule information database D310, the traffic information database D320 and the matching information database D330 is built by management of data stored in the auxiliary memory unit 303, by a program for a database management system (DBMS), the program being executed by the processor 301. Each of the schedule information database D310, the traffic information database D320 and the matching information database D330 is, for example, a relational database.

Any of the functional components of the server apparatus 300 or a part of processing in any of the functional components may be provided or performed by another computer connected to the network N1. For example, processing in the matching processing unit F330 and processings in the schedule information acquisition unit F310, the traffic information acquisition unit F320 and the matching information provision unit F340 may be performed by separate computers.

The schedule information acquisition unit F310 acquires schedule information from a user. The schedule information includes information relating to a first vehicle that a user is scheduled to ride in when the user visits a predetermined facility in addition to information relating to a schedule of the user's visit to the facility. Then, the schedule information acquisition unit F310 registers the schedule information in the schedule information database D310.

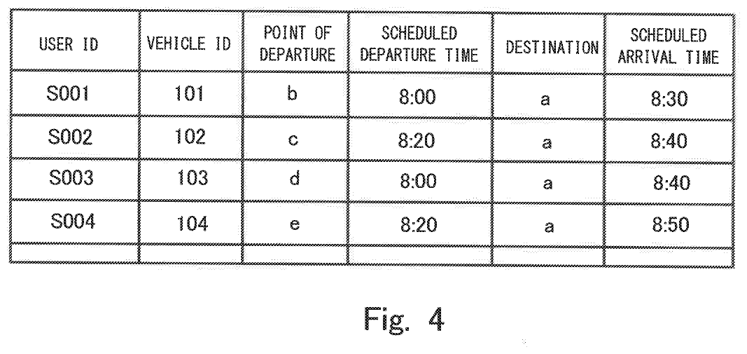

Here, the schedule information database D310 a database that stores schedule information. The schedule information database D310 includes a schedule information table, which is illustrated in FIG. 4. Information stored in the schedule information table is not limited to the example lustrated in FIG. 4 and arbitrary addition, change and deletion of fields are possible.

The schedule information table illustrated in FIG. 4 includes fields of user ID, vehicle ID, point of departure, scheduled departure time, destination and scheduled arrival time. Note that user information pieces each including a user ID are managed by a different table, and, e.g., contact information pieces of the users are included in the table. Each of the contact information pieces, for example, a mobile phone number or an e-mail address of the relevant user.

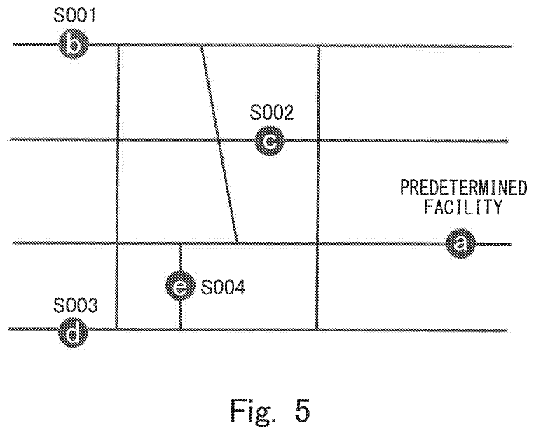

In the example illustrated in FIG. 4, users S001 to S004 are scheduled to head for destination a by respective vehicles (vehicles 101 to 104). In other words, in the schedule information table, the respective first vehicles (vehicles 101 to 104) for the users are specified. Then, the scheduled arrival times of the respective users' arrival at destination a fall within a range of 8:30 to 8:50. Here, it is assumed that destination a is a spot in which a predetermined facility is located. Also, an example of a positional relationship of destination a and points of departure of users S001 to S004 (spots b to e) is illustrated in FIG. 5.

Such schedule information is transmitted from each user terminal 200 to the server apparatus 300 by the user inputting the schedule information to the user terminal 200. More specifically, each user terminal 200 includes a functional configuration that receives an input of schedule information and transmits the input information to the server apparatus 300. The processor 201 of each user terminal 200 performs processing for transmitting schedule information input from the input unit 205, to the server apparatus 300 via the communication unit 206, according to a computer program in the main memory unit 202. Then, the schedule information acquisition unit F310 acquires the information transmitted from the user terminal 200.

Here, FIG. 3 is referred to again. The traffic information acquisition unit F320 acquires traffic information of traffic in the periphery of a predetermined facility (hereinafter simply referred to as “traffic information”), Note that the traffic information includes, e.g., information relating to a current condition of the traffic in the periphery of the predetermined facility, a capacity of a parking lot attached to the predetermined facility and the current number of vehicles parked and entrances of the parking lot. Then, the traffic information acquisition unit F320 registers the traffic information in the traffic information database D320.

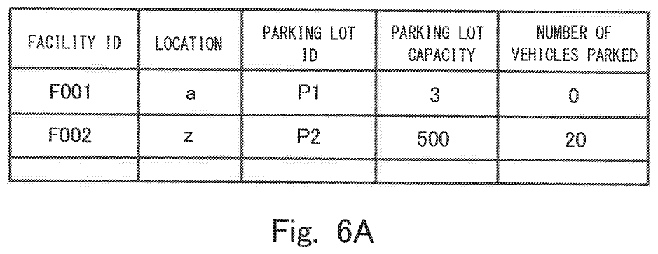

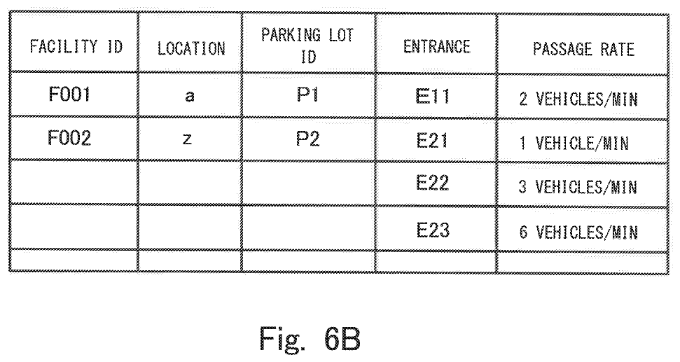

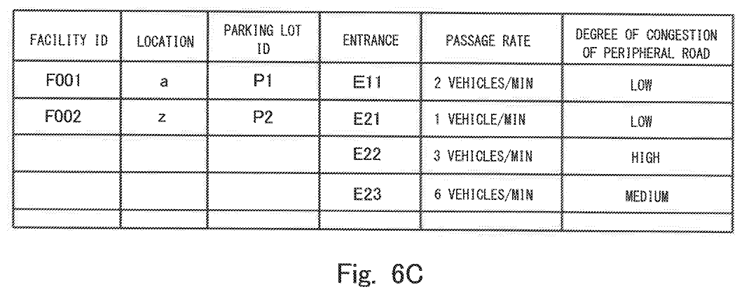

The traffic information database D320 is a database that stores traffic information. The traffic information database D320 includes traffic information tables illustrated in FIGS. 6A to 6C. Information stored in the traffic information table is not limited to the examples illustrated in FIGS. 6A to 6C and arbitrary addition, change and deletion of fields are possible. Also, the traffic information database D320 may include all of the traffic information tables illustrated in FIGS. 6A to 6C or may include a part of the traffic information tables.

The traffic information table illustrated in FIG. 6A includes fields of facility ID, location, parking lot ID, parking lot capacity, current number of vehicles parked. Here the facility ID, the location, the parking lot ID and the parking lot capacity can be acquired by reading information registered in a predetermined database in advance. Also, the current number of vehicles parked can be acquired based on a known method.

Also, the traffic information table illustrated in FIG. 6B includes fields of facility ID, location, parking lot ID, gate number of entrance of the parking lot (hereinafter simply referred to as “entrance”), number of vehicles that can pass through the entrance per minute (hereinafter referred to as “passage rate”). These information pieces can be acquired by reading information registered in a predetermined database in advance.

Also, the traffic information table illustrated in FIG. 6C includes a field of degree of congestion of a road in the periphery of the entrance (hereinafter, simply referred to as “degree of congestion”) in addition to the information pieces illustrated in FIG. 6B. The degree of congestion is represented by, for example, three levels, high, medium and low, and can be acquired based on a known method.

Here, FIG. 3 is referred to again. First, the matching processing unit F330 predicts whether or not congestion is caused by vehicles visiting a predetermined facility, based on schedule information acquired by the schedule information acquisition unit F310 and traffic information acquired by the traffic information acquisition unit F320. The prediction will be described in detail below.

For example, parking lot P1 of facility F001 indicated in the above-described FIG. 6A allows three vehicles to be parked therein and the current number of vehicles parked is 0. In this case, if the number of vehicles visiting facility F001 (visiting vehicles) during a predetermined period of time becomes equal to or larger than 4, parking lot P1 fails to accommodate all of the visiting vehicles, resulting in occurrence of congestion in the parking lot. Also, for example, parking lot P2 of facility F002 indicated in the above-described FIG. 6A allows 500 vehicles to be parked therein and the current number of vehicles parked is 20. In this case, for example, if the number of vehicles visiting facility F002 (visiting vehicles) during a predetermined period of time becomes equal to or larger than 450, congestion may occur in parking lot P2. Where the number of visiting vehicles is 450, the capacity of parking lot P2 has not yet been reached, but a vehicle entered parking lot P2 needs to seek a parking space and smooth parking of vehicles in the parking lot is this hindered.

Occurrence of congestion may also be determined by using the aforementioned passage rate. For example, parking lot P2 of facility F002 indicated in the above-described FIG. 6B has three entrances (E21 to E23) and parking lot P2 allows ten vehicles to be parked therein per minute. In this case, where 50 vehicles try to enter parking lot P2 in one minute, even if the parking lot is relatively empty, congestion may occur in a road leading to the parking lot. In this case, also, a degree of congestion of a road in the periphery of an entrance can be taken into consideration. For example, the above-described FIG. 6C indicates that the degree of congestion of a road in the periphery of entrance E22 of parking lot P2 is high and the degree of congestion of a road in the periphery of entrance E23 is medium. Then, where it is assumed that if the degree of congestion is medium, the passage rate becomes 0.5 times and if the degree of congestion is high, the passage rate becomes 0.1 times, the number of vehicles that can be accommodated by parking lot P2 per minute decreases to 4.3. Then, if a number of vehicles, the number being equal to or larger than this number, enter the parking lot, the road leading to the parking lot is further easily congested.

In view of the above, it can be understood that the number of visiting vehicles calculated based on schedule information pieces becomes equal to or larger than the first predetermined number, congestion may be caused by the vehicles. Here, as described above, the first predetermined number is a number set based on traffic information (e.g., the parking lot capacity, the current number of vehicles parked, the passage rate and the degree of congestion).

Then, if the number of visiting vehicles wising the predetermined facility during a predetermined period of time is predicted to be equal to or larger than the first predetermined number, processing in the calculation unit F331 of the matching processing unit F330 and processing in the matching unit F332 of the matching processing unit F330 are further performed. The present embodiment will be described in terms of a case where users S001 to S004 indicated in the above-described FIGS. 4 and 5 visit facility F001 at location a during a predetermined period of time, as an example. The predetermined period of time in the present example is, for example, a period of time from 8:30 to 9:00. Also, it is assumed that the first predetermined number is set based on the capacity of parking lot P1 and the number of vehicles parked in parking P1, which are indicated in the above-described FIG. 6A. The processor 301 functions as a control unit according to the present disclosure, by performing processing in the schedule information acquisition unit F310, processing in the calculation unit F331 and processing in the matching unit F332. Then, the server apparatus 300 functions as an information processing apparatus according to the present disclosure.

The calculation unit F331 of the matching processing unit F330 calculates ride-sharing user candidates and second vehicles. Here, a ride-sharing user candidate refers to a candidate of a user that joins a ride to visit a predetermined facility during a predetermined period of time. Here, ride-sharing refers to joining a ride in a vehicle that is different from a first vehicle specified in schedule information of the user himself/herself. Also, a second vehicle refers to a vehicle that a ride-sharing user candidate can join a ride in, the vehicle being a first vehicle for a user that is different from the ride-sharing user candidate. In other words, a first vehicle specified in schedule information for a user that is different from a ride-sharing user candidate can be a second vehicle for the ride-sharing user candidate. An example of the processing performed by the calculation unit F331 will be described with reference to the above-described FIGS. 4 and 5.

According to the above-described FIG. 5, it can be seen that when user S001 travels from spot b to spot a, the route is not particularly circuitous even if user S001 passes through spot c. Then, according to the above-described FIG. 4, it can be seen that user S002 heading for spot a from spot c is scheduled to arrive at spot a during a predetermined period of time that is the same as that of user S001. Therefore, the calculation unit F331 calculates user S002 as a ride-sharing user candidate and calculates vehicle 101 as a second vehicle for ride-sharing user candidate S002. In this case, it is determined, that user S002 can join a ride in vehicle 101 that user S001 rides in.

Also, according to the above-described FIG. 5, it can be seen that when user S003 travels from spot d to spot a, the route is not particularly circuitous even if user S003 passes through spot e. Then, according to the above-described FIG. 4, it can be seen that user S004 heading for spot a from spot e is scheduled to arrive at spot a during a predetermined period of time that is the same as that of user S003. Therefore, the calculation unit F331 calculates user S004 as a ride-sharing user candidate and calculates vehicle 103 as a second vehicle for the ride-sharing user candidate S004. In this case, it is determined that user S004 can join a ride in vehicle 103 that user S003 rides in.

In the present embodiment, as described above, the calculation unit F331 calculates user S002 and user S004 as ride-sharing user candidates and calculates vehicle 101 as a second vehicle for user S002 and vehicle 103 as a second vehicle for user S004. Then, next, the matching unit F332 of the matching processing unit F330 performs matching between a part or all of users in the calculated ride-sharing user candidates and the second vehicles so that the number of visiting vehicles becomes smaller than the first predetermined number.

As described above, if the number of vehicles visiting facility F001 indicated in the above-described FIG. 6A (visiting vehicles) during a predetermined period of time becomes equal to or larger than 4, parking lot P1 falls to accommodate all of the visiting vehicles, resulting in occurrence of congestion in the parking lot. Therefore, the matching unit F332 performs matching between ride-sharing user candidate S002 and second vehicle 101 and/or matching between ride-sharing user candidate S004 and second vehicle 103 so that the number of visiting vehicles becomes smaller than 4.

Then, after matching between the ride-sharing user candidate(s) and the second vehicle(s), the matching unit F332 generates matching information. Here, the matching information is information to be registered in the matching information database D330.

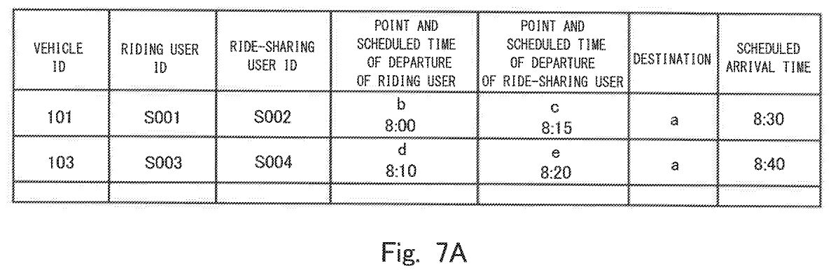

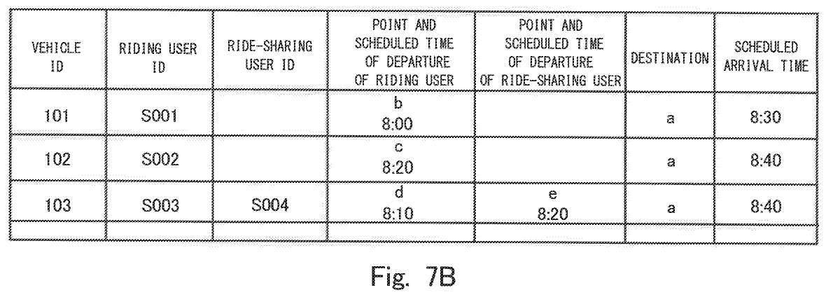

The matching information database D330 is a database that stores matching information. The matching information database D330 includes a matching information table, which is illustrated in FIG. 7A or 7B. Here, information stored in the matching information table is not limited to the example illustrated in FIG. 7A or 7B, and arbitrary addition, change and deletion of fields are possible.

The matching information table illustrated in FIG. 7A includes fields of vehicle ID, user ID of a riding user specified. in schedule information, user ID of a ride-sharing user candidate matched with the relevant vehicle (ride-sharing user), point and scheduled time of departure of the riding user, point and scheduled time of departure of the ride-sharing user, destination and scheduled arrival time. In the present example, ride-sharing user S002 is matched with vehicle 101 and ride-sharing user S004 is matched with vehicle 103. Here, a riding user that rides in a vehicle with which a ride-sharing user is matched is, for example, a driver of the vehicle. However, the above is not intended to limit the riding user to this example and, for example, where a vehicle is an autonomous moving body that autonomously moves based on a predetermined operation instruction, as described above, the riding user is a user specified in schedule information.

On the other hand, as in the matching information table illustrated in FIG. 7B, a ride-sharing user may be matched with vehicle 103 from among vehicles 101 and 103 calculated as second vehicles.

Then, such matching information is provided to the ride-sharing user(s) matched with the second vehicle(s) and the riding user(s) of the second vehicle(s), by the matching information provision unit F340 illustrated in FIG. 3. At this time, the matching information provision unit F340 provides the matching information and requests an approval of the matching from each user. A user that has approved the matching can travel by vehicle based on the matching information.

### Flow of Processing

The flow of processing in the server apparatus 300 according to the present embodiment will be described. FIG. 8 is a flowchart of processing performed by the server apparatus 300.

In the processing in FIG. 8, first, in step S101, schedule information pieces are acquired and the information pieces are registered. In step S101, the server apparatus 300 acquires the schedule information pieces transmitted from user terminals 200, through reception by the communication unit 304, and registers the schedule information pieces in the schedule information database D310. As described above, the schedule information pieces each include information relating to a first vehicle.

Next, in step S102, traffic information is acquired. In step S102, the server apparatus 300 can acquire a capacity of a parking lot, which is a piece of traffic information, by, for example, reading information registered in a predetermined database in advance, and acquire the current number of vehicles parked, which is a piece of traffic information, based on a known method.

Next, in step S103, whether or not the number of visiting vehicles is predicted to be equal to or larger than a first predetermined number is determined. Here, the server apparatus 300 can calculate the number of first vehicles scheduled to visit a predetermined facility during a predetermined period of time in the schedule information pieces acquired in step S101, as the number of visiting vehicles. Also, the server apparatus 300 can determine the first predetermined number based on the traffic information pieces acquired in step S102. Then, if an affirmative determination is made in step S103, the processor 301 of the server apparatus 300 proceeds to the processing in step S104 and if a negative determination is made in step S103, the execution of the present flow ends.

If an affirmative determination is made in step S103, next, in step S104, ride-sharing user candidates and second vehicles are calculated. Then, in step D105, matching between a part or all of users in the ride-sharing user candidates calculated in step D104 and the second vehicles is performed so that the number of visiting vehicles becomes smaller than the first predetermined number. Here, details of the processing by the calculation unit F331, which is performed in step D104, and the processing by the matching unit F332, which is performed in step D105, are as described above.

Next, in step S106, matching information pieces on the matching according to the processing in step S105 are transmitted. In step S106, the server apparatus 300 transmits the matching information pieces to the relevant user terminals 200. Then, ride-sharing users matched with the respective second vehicles and riding users of the second vehicles can acquire the respective matching information pieces. Then, each of these users transmits information on whether or not to approve the matching, using the relevant user terminal 200, to the server apparatus 300. Then, in step S107, the server apparatus 300 determines whether or not the matching according to the processing in step S105 has been approved by the user. Then, if an affirmative determination is made in step S107, the processor 301 proceeds to processing in step S108 and if a negative determination is made in step S107, the processor 301 proceeds to the processing in step S105.

If an affirmative determination is made in step S107, next, in step S108, the matching information piece approved by the user is registered. In step S108, the server apparatus 300 registers the relevant matching information piece in the matching information database D330. Then, after the processing in step S108, execution of the present flow ends.

The above-described information processing system suppresses congestion caused by visiting vehicles visiting a predetermined facility during a predetermined period of time to the extent possible. In other words, the information processing apparatus according to the present disclosure can provide a ride-sharing system that enables alleviation of congestion caused by visiting vehicles.

### Recording Medium

A program that causes a computer or other machine or apparatus (hereinafter, “computer or the like”) to provide any of the above-described functions can be recorded in a recording medium that can be read by the computer or the like. The function can be provided by causing the computer or the like to read and execute the program in the recording medium.

Here, the recording medium that can be read by the computer or the like refers to a non-transitory recording medium that can store information such as data or a program by means of an electrical, magnetic, optical, mechanical or chemical action and allows the information to be read by the computer or the like. Examples of a recording medium that can be removed from the computer or the like from among such recording media include a flexible disk, a magnetooptical disk, a CD-ROM, a CD-R/W, a DVD, a Elu-ray disk, a DAT, an 8 mm tape and a memory card such as a. flash memory. Also, examples of a recording medium fixed in the computer or the like from among such recording media include, e.g., a hard disk and a ROM (read-only memory). Furthermore, an SSD (solid-state drive) can he used as a recording medium that can be removed from the computer or the like or a recording medium fixed in the computer or the like.

### Alteration of the First Embodiment

Next, an alteration of the above-described first embodiment will be described. In the present alteration, detailed description of components that are substantially the same as those of the first embodiment and control processing that is substantially the same as that of the first embodiment will be omitted.

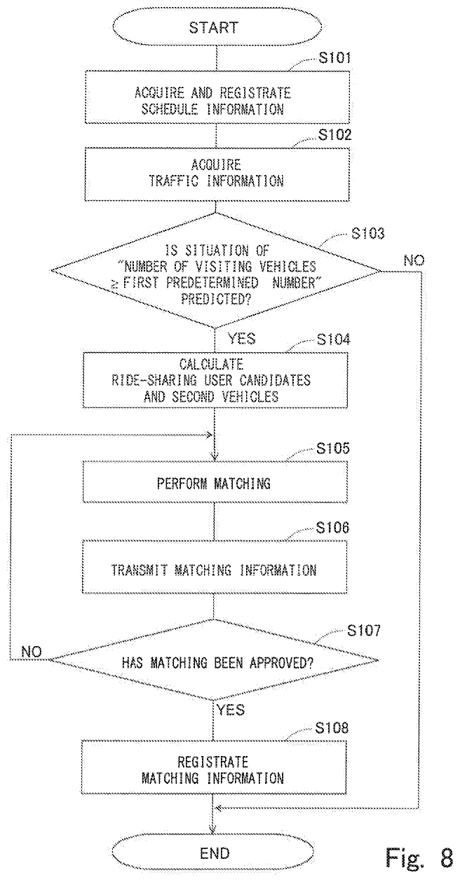

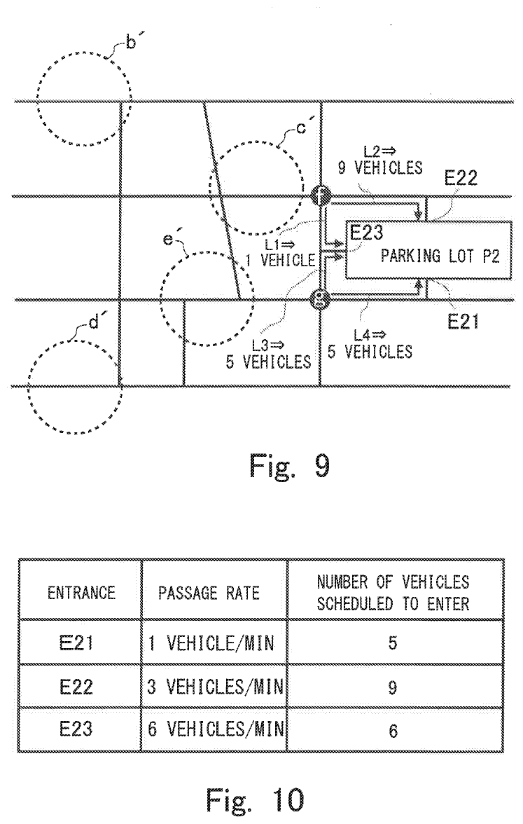

In the above-described first embodiment, the number of visiting vehicles is reduced by performing ride-sharing matching. Consequently, congestion of a parking lot attached to a predetermined facility and congestion of a road leading to the parking lot can be suppressed; however, depending on the travel routes of visiting vehicles to the facility, congestion may still occur in the periphery of the parking lot. Therefore, in the present alteration, the server apparatus 300 generates a travel route in the periphery of a predetermined facility for each of a part or all of a plurality of visiting vehicles. This will be described with reference to FIGS. 9 to 13.

FIG. 9 is a diagram illustrating an example of travel routes in the periphery of facility F002 indicated in the above-described FIG. 6B for visiting vehicles to enter parking lot P2 of facility F002. In the example illustrated in FIG. 9, it is assumed that ride-sharing matching is performed so that a plurality of visiting vehicles depart from area b' and the visiting vehicles have respective ride-sharing users join a ride in area c′ and a plurality of visiting vehicles depart from area d′ and the visiting vehicles have respective ride-sharing users join a ride in area e′. Then, it is assumed that the visiting vehicles from area b′ enter parking lot P2 through route L1 or route L2 via spot f and the visiting vehicles from area d′ enter parking lot P2 through route L3 or route L4 via spot g.

Here, a case where ten visiting vehicles from area b′ and ten visiting vehicles from area d′ schedule to enter parking lot P2 during a same period of time is assumed. In this case, as described above with reference to FIG. 6B, parking lot P2 can accommodate ten vehicles per minute, and thus, if ride-sharing matching is performed so that the number of visiting vehicles becomes 20, congestion seems less likely to be caused by the visiting vehicles. However, here, if one vehicle passes through route L1, nine vehicles pass through route L2, five vehicles pass through route L3 and five vehicles pass through route L4, congestion may occur in route L4 leading to entrance E21 of parking lot P2. This is because entrance E21 has a passage rate of one vehicle/min as indicated in FIG. 10, it takes at least five minutes for the five vehicles to enter from entrance E21. Also, the entrance E22 has a passage rate of three vehicles/min, and thus it takes at least three minutes for the nine vehicles to enter from entrance E22.

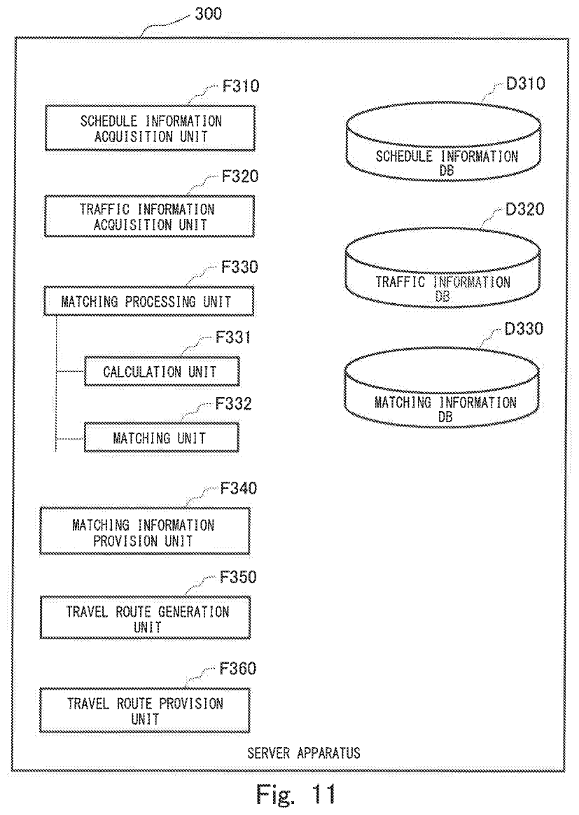

Therefore, as illustrated in FIG. 11, a server apparatus 300 according to the present alteration includes a travel route generation unit F350 and a travel route provision unit F360 in addition to the functional components mentioned in the description of the first embodiment. A processor 301 of the server apparatus 300 performs processing in the travel route generation unit F350 and processing in the travel route provision unit F360 according to a computer program in a main memory unit 302. However, any of the functional components or a part of the processing in any of the functional components may be provided or performed by a hardware circuit.

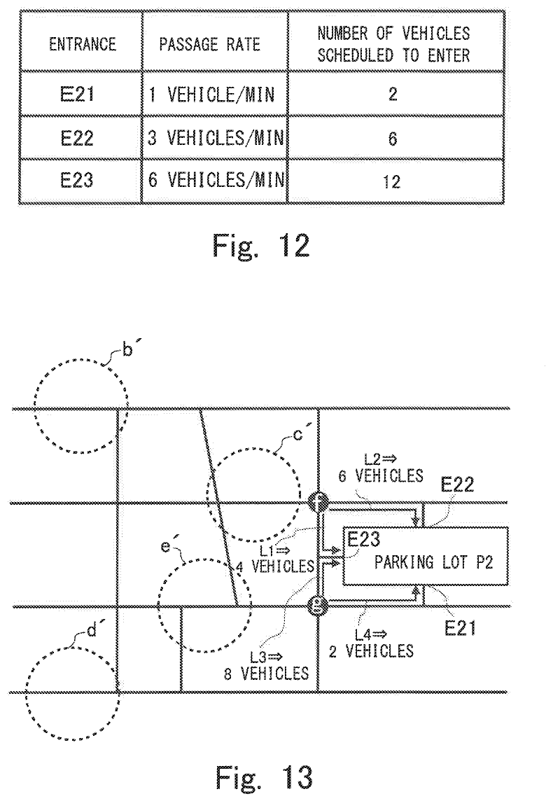

The travel route generation unit F350 generates a travel route in the periphery of a predetermined facility (hereinafter simply referred to as “travel route”) for each of a part or all of a plurality of visiting vehicles. More specifically, the travel route generation unit F350 generates the travel routes so that the number of vehicles having a predetermined route from among the visiting vehicles for which the travel route has been generated by the travel route generation unit F350 becomes equal to or smaller than a second predetermined number. This will be described with reference to FIGS. 12 and 13.

In the present alteration, travel routes of 20 visiting vehicles including ten visiting vehicles from area b′ and ten visiting vehicles from area d′ are generated so that the number of vehicles scheduled to enter each of the entrances of parking lot P2 illustrated in the above-described FIG. 9 becomes no more than twice the relevant passage rate. Then, as illustrated in FIG. 12, the number of vehicles scheduled to enter entrance E21 is two, the number of vehicles scheduled to enter entrance E22 is six and the number of vehicles scheduled to enter entrance E23 is twelve. In this case, as illustrated in FIG. 13, the travel route generation unit F350 generates travel routes for the visiting vehicles so that the number of vehicles having route L1 from spot f to entrance E23 from among the 20 visiting vehicles becomes four. Likewise, the travel route generation unit F350 generates travel routes for the visiting vehicles so that the number of vehicles having route L2 from spot f to entrance E22 becomes six, the number of vehicles having route L3 from spot g to entrance E23 becomes eight and the number of vehicles having route L4 from spot g to entrance E21 becomes two.

Accordingly, time taken for the vehicles to enter the parking lot from the respective entrances is reduced to be equal or shorter than a predetermined length of time and congestion caused by visiting vehicles is thus suppressed. Here, each of routes L1, L2, L3, L4 corresponds to the above predetermined route. Also, in the present alteration, the second predetermined number for each route defined so that the number of vehicles scheduled to enter a relevant entrance connected to the route becomes no more than twice the passage rate of the entrance.

Then, the travel routes generated as described above are provided to the visiting vehicles by the travel route provision unit F360 illustrated in FIG. 11. In the present alteration, the server apparatus 300 provides the respective travel routes to the visiting vehicles by transmitting the respective travel routes to respective in-vehicle apparatuses of the visiting vehicles. Here, each in-vehicle apparatus includes, e.g., a communication unit, a GPS device or a navigation system that is connectable to a network N1. However, the above is not intended to limit the method of provision of the travel routes thereto and the travel routes may be provided to the visiting vehicles by the server apparatus 300 transmitting the travel routes to relevant user terminals 200. Then, each of users driving the respective visiting vehicles can make the vehicle travel along the provided travel route (the travel route is displayed on a screen of the navigation system included in the in-vehicle apparatus or a screen of the user terminal 200). Also, if a visiting vehicle is an autonomous moving body that autonomously moves based on a predetermined operation instruction, the server apparatus 300 transmits a travel route to a predetermined operation management server and the travel route is thereby provided to the visiting vehicle via the operation management server.

Here, the processor 301 functions as a control unit accord in to the present disclosure by performing the processing in the schedule information acquisition unit F310, the processing in the calculation unit F331, the processing in the matching unit F332, the processing in the travel route generation, unit F350 and the processing in the travel route provision unit F360.

The information processing system described above enables congestion caused by visiting vehicles visiting a predetermined facility during a predetermined period of time to be suppressed to the extent possible.

### Second Embodiment

Next, a second embodiment of the present disclosure will be described. In the present embodiment, detailed description of components that are substantially the same as those of the first embodiment and control processing that is substantially the same as that of the first embodiment will be omitted.

In the above-described first embodiment, the server apparatus 300 acquires schedule information pieces through communication with user terminals 200. Then, the server apparatus 300 performs matching between ride-sharing user candidates and second vehicles and transmits matching information pieces on the matching to the user terminals 200. On the other hand, in the present embodiment, a server apparatus 300 acquires schedule information pieces through communication with a management server that manages schedule information pieces for users using the information processing system 1. Also, the server apparatus 300 performs matching between ride-sharing user candidates and second vehicles and transmits matching information on the matching to the management server.

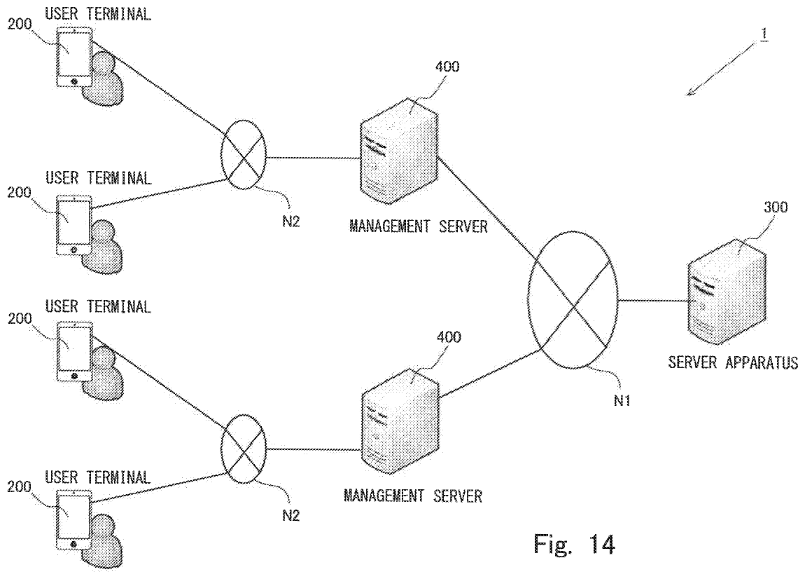

FIG. 14 is a diagram illustrating a schematic configuration of an information processing system according to the present embodiment. In the example in FIG. 14, an information processing system 1 includes user terminals 200, a server apparatus 300 and management servers 400. Here, each of the management servers 400 is a server apparatus that collectively manages schedule information pieces of users belonging to a predetermined group, and the information processing system 1 includes a number of management servers 400, the number corresponding to the number of predetermined groups using the system. Here, a predetermined group is, for example, a company-based group.

In the information processing system 1, the server apparatus 300 and the management servers 400 are interconnected by a network N1. Also, each user terminal 200 and a relevant management server 400 are interconnected via a network N2. Here, for the networks N2, for example, a WAN (wide area network), which is a worldwide public communication network such as the Internet or another communication network, may be employed. Also, the network N2 may include a telephone communication network for, e.g., mobile phones and a wireless communication network for, e.g., WiFi.

Also, the management server 400 has a hardware configuration that is similar to that of the server apparatus 300, and includes a processor 401, a main memory unit 402, an auxiliary memory unit 403 and a communication unit 404. Furthermore, the management server 400 includes a schedule information acquisition unit F410, a matching information provision unit F440 and a schedule information database D410 as functional components. These functional components function in such a manner that is similar to the schedule information acquisition unit F310, t be matching information provision unit F340 and the schedule information database D310 mentioned in the description of the first embodiment, respectively.

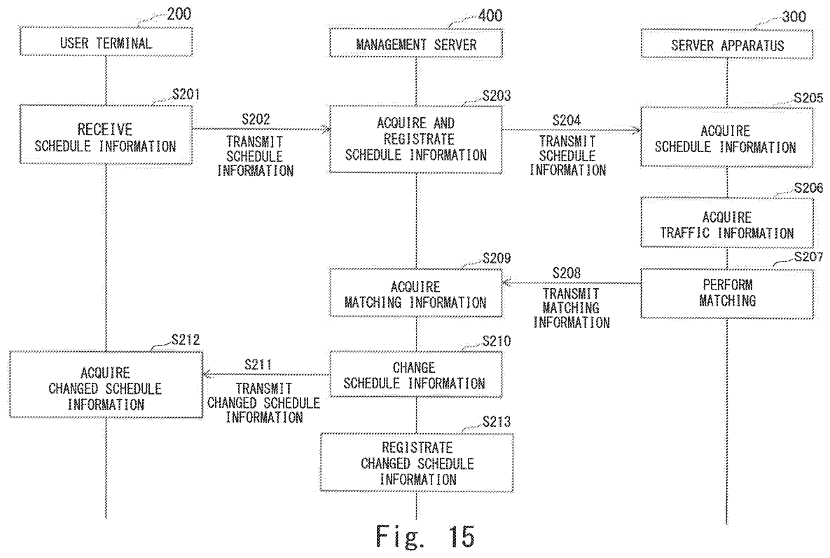

Here, the flow of operation of the information processing system according to the present embodiment will be described. FIG. 15 is a diagram illustrating an example of the flow of operation of the information processing system according to the present embodiment. FIG. 15 indicates the flows of operation between the respective components and processing performed in each component in the information processing system 1.

In the present embodiment, first, schedule information pieces are registered by respective users. Each user terminal 200 receives a schedule information piece from the relevant user (step S201) and transmits the schedule information piece to the management server 400 (step S202). Then, a relevant management server 400 acquires the schedule information piece transmitted from the user terminal 200 through reception by the communication unit 404 and registers the schedule information piece in the schedule information database D410 (step S203). Furthermore, the management server 400 transmits the schedule information piece to the server apparatus 300 (step S204). Then, the server apparatus 300 acquires the schedule information pieces transmitted from the management server 400 through reception by the communication unit 304 (step S205).

Next, the server apparatus 300 acquires traffic information (step S206). Then, if the number of visiting vehicles is predicted to be equal to or larger than a first predetermined number (if an affirmative determination is made in step S103 in FIG. 8 referred to above), the server apparatus 300 calculates ride-sharing users and second vehicles (step S104 in FIG. 8 referred to above) and performs matching between the ride-sharing user candidates and the second vehicles (step S207). After the matching in step S207, the server apparatus 300 generates matching information and transmits the matching information to the management server 400 (step S208). Here, the matching information in the present embodiment includes ride-sharing requests that each request for sharing a ride in a second vehicle to visit the predetermined facility in addition to results of the matching between the ride-sharing user candidates and the second vehicles. Each ride-sharing request is information for requesting a ride-sharing user matched with a second vehicle to join a ride in the second vehicle to visit the predetermined facility. Also, each ride-sharing request can include information for requesting a user originally scheduled to ride in a second vehicle for which a ride-sharing user is set, to share a ride in the second vehicle with the ride-sharing user.

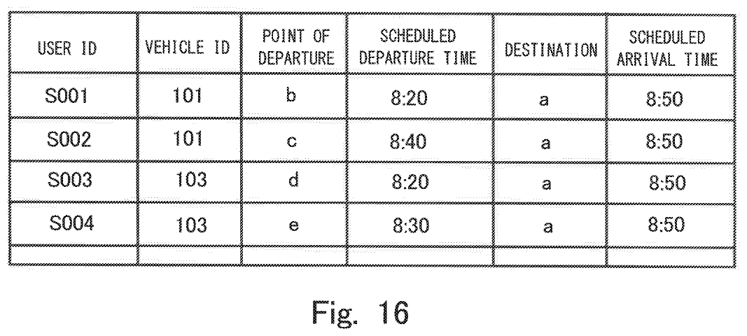

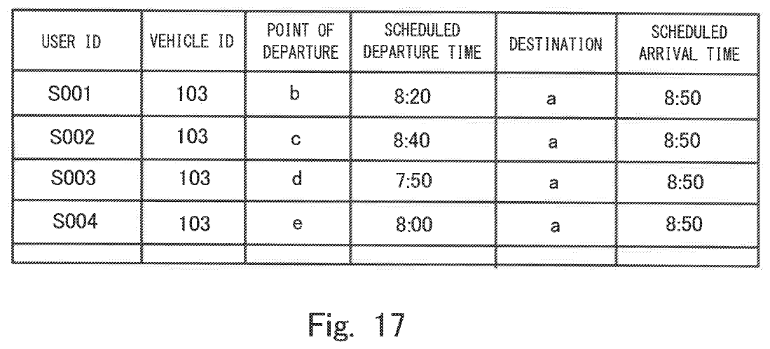

The management server 400 acquires the matching information including the ride-sharing requests (step S209) and changes schedule information pieces of the ride-sharing users matched with the second vehicles (step S210). This will be described based on FIGS. 16 and 17.

FIG. 16 is a diagram illustrating an example of the schedule information table registered in the schedule information database D410 in step S203. Users S001 to 5004 illustrated in FIG. 16 are users belonging to a same group, Here, in the present embodiment, as illustrated in FIG. 16, scheduling is performed so that users S001 and S002 ride in vehicle 101 and users S003 and S004 ride in vehicle 103. In other words, a first vehicle for users S001 and S002 is vehicle 101 and a first vehicle for users S003 and S004 is vehicle 103.

Here, it is assumed that users S001 and S002 and vehicle 103 are matched with each other as a result of the matching in step S207. In this case, users S001 and S002 correspond to ride-sharing users according to the present disclosure and vehicle 103 correspond to a second vehicle for uses S001 and S002. Then, as illustrated in FIG. 17, a relevant management server 400 changes schedule information pieces of ride-sharing users S001 and S002 matched with vehicle 103. More specifically, the vehicle that users S001 and S002 scheduled to ride in is changed from vehicle 101 to vehicle 103 and respective scheduled departure times are changed. Along with change in number of people to ride in vehicle 103, respective schedule departure times for users S003 and S004 are also changed.

Then, the management server 400 transmits the schedule information pieces changed as described above to the respective user terminals 200 (step S211). Then, the user terminals 200 acquire the respective changed schedule information pieces (step 8212). Also, the management server 400 registers the changed schedule information pieces in the schedule information database D410 (step S213).

As a result of the schedule information pieces of the users being managed by the management servers 400 as described above, burden on the server apparatus 300 is reduced. Here, when the management server 400 changes the schedule information pieces as described above, the management server 400 may request an approval of each user. Also, the server apparatus 300 may perform matching so that users belonging to different groups ride in a same vehicle.

The information processing system described above also suppresses congestion caused by visiting vehicles visiting a predetermined facility during a predetermined period of time to the extent possible. In other words, the information processing apparatus according to the present disclosure can provide a ride-sharing system that enables alleviation of congestion caused by visiting vehicles

### Other Embodiments

Each of the above-described embodiments is a mere example and the present disclosure can be carried out with arbitrary change made thereto without departing from the spirit of the disclosure.

Also, the processing and measures described in the present disclosure can freely be combined and carried out as long as such combination causes no technical contradiction.

Also, the processing described as processing performed by a single apparatus may be shared and performed by a plurality of apparatuses. Alternatively, the processing described as processing performed by different apparatuses may be performed by a single apparatus. In a computer system, what hardware configuration (server configuration) to be employed to provide the respective functions can flexibly be changed.

The present disclosure can also be carried out by supplying computer programs implementing the functions described in the above embodiments to a computer and causing one or more processors included in the computer to read and execute the programs. Such computer programs may be provided to the computer via a non-transitory computer-readable recording medium that is connectable to a system bus of the computer or may be provided to the computer via a network. Examples of the non-transitory computer-readable recording medium include arbitrary types of disks including magnetic disks (e.g., a floppy (registered trademark) disk and a hard disk drive (HDD)), optical disks (e.g., a CD-ROM, a DVD disk and a Blu-ray disk), a read-only memory (ROM), a random access memory (RAM), an EPROM, an EEPROM, a magnetic card, a flash memory, an optical card, and an arbitrary type of medium suitable for storing electronic instructions.

What is claimed is:

1. An information processing apparatus comprising a control unit configured to:
for each of a plurality of visitors who visit a predetermined facility by vehicle, acquire a schedule information piece which is an information piece relating to a schedule for the visitor to visit to the facility, a first vehicle being specified in the schedule information piece, the first vehicle being a vehicle that the visitor schedules to ride in when the visitor visits the facility; and
if the number of a plurality of visiting vehicles visiting the predetermined facility during a predetermined period of time is predicted to be equal to or larger than a first predetermined number based on the respective schedule information pieces of the plurality of visitors, calculate ride-sharing user candidates that are candidates of visitors that each join a ride in a vehicle, that is different from the first vehicle specified in the schedule information piece of the relevant visitor, to visit the predetermined facility during the predetermined period of time, from among the plurality of visitors, and second vehicles that are vehicles that the ride-sharing user candidates can join a ride in, each of the second vehicles being the first vehicle for a visitor that is different from the ride-sharing user candidates, and perform matching between a part or all of users in the calculated ride-sharing user candidates and the second vehicles so that the number of the plurality of visiting vehicles becomes smaller than the first predetermined number.

2. The information processing apparatus according to claim 1, wherein the control unit, further,
acquires the respective schedule information pieces of the plurality of visitors from a management server that manages the respective schedule information pieces for the plurality of visitors; and
if the matching is performed, transmits a result of the matching and a ride-sharing request for requesting sharing a ride in the second vehicle to visit the predetermined facility, to the management server.

3. The information processing apparatus according to claim 1, wherein the control unit, further,
for each of a part or all of vehicles of the plurality of visiting vehicles, generates a travel route in a periphery of the predetermined facility and generates the travel routes so that the number of vehicles having a predetermined route from among the visiting vehicles for which the respective travel routes have been generated is equal to or smaller than a second predetermined number; and
provides the generated travel routes to the respective visiting vehicles for which the travel routes have been generated.

4. The information processing apparatus according to claim 2, wherein the control unit, further,
for each of a part or all of vehicles of the plurality of visiting vehicles, generates a travel route in a periphery of the predetermined facility and generates the travel routes so that the number of vehicles having a predetermined route from among the visiting vehicles for which the respective travel routes have been generated is equal to or smaller than a second predetermined number; and
transmits the generated travel routes to the management server.

5. The information processing apparatus according to claim 1, wherein the first predetermined number is determined based on a capacity of a parking lot attached to the predetermined facility.

6. An information processing method comprising the steps of:
for each of a plurality of visitors who visit a predetermined facility by vehicle, acquiring a schedule information piece whish is an information piece relating to a schedule for the visitor to visit to the facility, a first vehicle being specified in the schedule information piece, the first vehicle being a vehicle that the visitor schedules to ride in when the visitor visits the facility; and
if the number of a plurality of visiting vehicles visiting the predetermined facility during a predetermined period of time is predicted to be equal to or larger than a first predetermined number based on the respective schedule information pieces of the plurality of visitors, calculating ride-sharing user candidates that are candidates of visitors that each join a ride in a vehicle that is different from the first vehicle specified in the schedule information piece of the relevant visitor, to visit the predetermined facility during the predetermined period of time, from among the plurality of visitors, and second vehicles that are vehicles that the ride-sharing user candidates can join a ride in, each of the second vehicles being the first vehicle for a visitor that is different from the ride-sharing user candidates, and performing matching between a part or all of users in the calculated ride-sharing user candidates and the second vehicles so that the number of the plurality of visiting vehicles becomes smaller than the first predetermined number.

7. A non-transitory recording medium storing a program for causing a computer to perform the steps of:
for each of a plurality of visitors who visit a predetermined facility by vehicle, acquiring a schedule information piece which is an information piece relating to a schedule for the visitor to visit to the facility, a first vehicle being specified in the schedule information piece, the first vehicle being a vehicle that the visitor schedules to ride in when the visitor visits the facility; and
if the number of a plurality of visiting vehicles visiting the predetermined facility during a predetermined period of time is predicted to be equal to or larger than a first predetermined number based on the respective schedule information pieces of the plurality of visitors, calculating ride-sharing user candidates that are candidates of visitors that each join a ride in a vehicle that is different from the first vehicle specified in the schedule information piece of the relevant visitor, to visit the predetermined facility during the predetermined period of time, from among the plurality of visitors, and second vehicles that are vehicles that the ride-sharing user candidates can join a ride in, each of the second vehicles being the first vehicle for a visitor that is different from the ride-sharing user candidates, and performing matching between a part or all of users in the calculated ride-sharing user candidates and the second vehicles so that the number of the plurality of visiting vehicles becomes smaller than the first predetermined number.
